(19) United States
(12) Patent Application Publication
(10) Pub. No.: US 2023/0308624 A1
(43) Pub. Date: Sep. 28, 2023

(54) STEREOSCOPIC DISPLAY SYSTEM AND METHOD

(71) Applicant: AUO Corporation, Hsin-chu (TW)

(72) Inventors: Ya-Ting CHEN, HSIN-CHU (TW); Sheng-Wen CHENG, HSIN-CHU (TW)

(21) Appl. No.: 17/980,929

(22) Filed: Nov. 4, 2022

(30) Foreign Application Priority Data
Mar. 22, 2022 (TW) 111110652

(51) Int. Cl. H04N 13/117; H04N 13/383; H04N 13/31

(52) U.S. Cl. CPC H04N 13/117; H04N 13/383; H04N 13/31

(57) ABSTRACT

A stereoscopic display system and method are provided. The system calculates a viewing angle of a user corresponding to a display panel. The system calculates a first display pixel area arrangement and a second display pixel area arrangement of a parallax filter corresponding to the display panel. The system determines a first display pixel area, a second display pixel area, and a no-value pixel area corresponding to the display panel based on the first display pixel area arrangement and the second display pixel area arrangement. The system analyzes the first display pixel area and the second display pixel area adjacent to the no-value pixel area to generate a compensation value corresponding to each of the pixels in the no-value pixel area.

### CROSS-REFERENCE TO RELATED APPLICATION

This application claims priority to Taiwan Application Serial Number 111110652, filed Mar. 22, 2022, which is herein incorporated by reference in its entirety.

### BACKGROUND

### Field of Invention

The present invention relates to a stereoscopic display system and method. More particularly, the present invention relates to a naked-eye stereoscopic display system and method.

### Description of Related Art

In the conventional naked-eye stereoscopic display system, the stereoscopic display system provides images with parallax for the left and right eyes respectively, so as to provide the user's eyes with a stereoscopic display effect.

However, in the existing naked-eye stereoscopic display system, there are problems such as users' different viewing angles, the parallax filter's light-splitting mechanism cannot be completely perfect, etc. It will cause the data of the pixel area that should not be seen by the user's eyes to be seen, and then lead to the appearance of flawed images such as dark lines and the like.

Accordingly, there is an urgent need for a technology that can determine the no-value pixel area and compensate for the no-value pixel area.

### SUMMARY

An objective of the present disclosure is to provide a stereoscopic display system. The stereoscopic display system comprises an eye tracking device, a display panel, a parallax filter, and a processing device. The eye tracking device is configured to sense a left eyeball position and a right eyeball position of a user. The display panel is configured to display a plurality of pixels. The parallax filter is configured to guide the pixels on the display panel to the left eyeball position and the right eyeball position. The processing device calculates a viewing angle of the user corresponding to the display panel. The processing device calculates a first display pixel area arrangement and a second display pixel area arrangement of the display panel corresponding to the parallax filter, wherein the first display pixel area arrangement and the second display pixel area arrangement comprise a pixel value corresponding to each of the pixels. The processing device determines a first display pixel area, a second display pixel area, and a no-value pixel area corresponding to the display panel based on the first display pixel area arrangement and the second display pixel area arrangement. The processing device analyzes the first display pixel area and the second display pixel area adjacent to the no-value pixel area to generate a compensation value corresponding to each of the pixels in the no-value pixel area.

Another objective of the present disclosure is to provide a stereoscopic display method, which is adapted for use in a stereoscopic display system. The stereoscopic display system comprises an eye tracking device, a display panel, a parallax filter, and a processing device. The eye tracking device is configured to sense a left eyeball position and a right eyeball position of a user. The display panel is configured to display a plurality of pixels. The parallax filter is configured to guide the pixels on the display panel to the left eyeball position and the right eyeball position. The stereoscopic display method comprises following steps: calculating a viewing angle of the user corresponding to the display panel; calculating a first display pixel area arrangement and a second display pixel area arrangement of the display panel corresponding to the parallax filter, wherein the first display pixel area arrangement and the second display pixel area arrangement comprise a pixel value corresponding to each of the pixels; determining a first display pixel area, a second display pixel area, and a no-value pixel area corresponding to the display panel based on the first display pixel area arrangement and the second display pixel area arrangement; and analyzing the first display pixel area and the second display pixel area adjacent to the no-value pixel area to generate a compensation value corresponding to each of the pixels in the no-value pixel area.

According to the above descriptions, the stereoscopic display technology (at least including the system and method) provided by the present disclosure calculates the viewing angle of the display panel corresponding to the user, and calculates a first display pixel area arrangement and a second display pixel area arrangement of the display panel corresponding to the parallax filter. In addition, based on the first display pixel area arrangement and the second display pixel area arrangement, a first display pixel area, a second display pixel area and a no-value pixel area corresponding to the display panel are determined. Finally, the present disclosure analyzes the first display pixel area and the second display pixel area adjacent to the no-value pixel area to generate a compensation value corresponding to each of the pixels in the no-value pixel area. The stereoscopic display technology provided by the present disclosure generates the compensation value of each pixel in the no-value pixel pixel area by determining the no-value pixel area and considering the values of the adjacent pixels. Therefore, the present disclosure can solve the problem of defective images such as black lines when users use the stereoscopic display system. In addition, the stereoscopic display technology provided by the present disclosure can make real-time compensation for each pixel in the no-value pixel area, so that the picture quality of the naked-eye stereoscopic display can be further improved.

The detailed technology and preferred embodiments implemented for the subject disclosure are described in the following paragraphs accompanying the appended drawings for people skilled in this field to well appreciate the features of the claimed disclosure.

### BRIEF DESCRIPTION OF THE DRAWINGS

FIG. 1A is a schematic diagram depicting the applicable scene of the naked-eye stereoscopic display system of the first embodiment;

FIG. 1B is a schematic diagram depicting the stereoscopic display system of the first embodiment;

FIG. 2A is a schematic diagram depicting a viewing angle;

FIG. 2B is a schematic diagram depicting a viewing angle;

FIG. 3A is a schematic diagram depicting a first display pixel area arrangement;

FIG. 3B is a schematic diagram depicting a second display pixel area arrangement;

FIG. 4A is a schematic diagram depicting a first display pixel area arrangement;

FIG. 4B is a schematic diagram depicting a second display pixel area arrangement;

FIG. 5A is a schematic diagram depicting a first display pixel area arrangement;

FIG. 5B is a schematic diagram depicting a second display pixel area arrangement; and

FIG. 6 is a partial flowchart depicting the stereoscopic display method of the second embodiment.

### DETAILED DESCRIPTION

In the following description, a stereoscopic display system and method according to the present disclosure will be explained with reference to embodiments thereof. However, these embodiments are not intended to limit the present disclosure to any environment, applications, or implementations described in these embodiments. Therefore, the description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

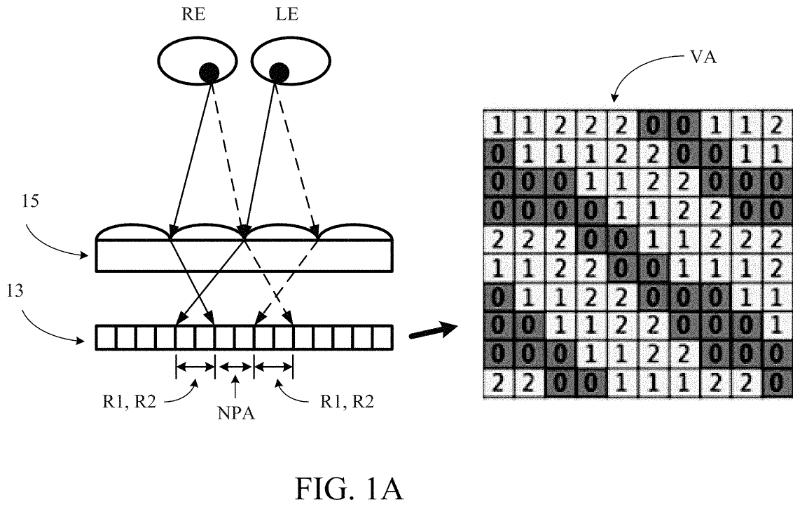

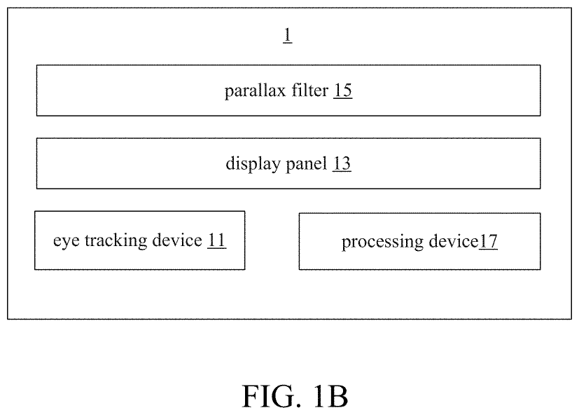

First, the applicable scene of the naked-eye stereoscopic display system is described, and its schematic diagram is depicted in FIG. 1A. It shall be appreciated that the naked-eye stereoscopic display system provides images with parallax for the left eye and the right eye, which are called viewpoint images.

As shown in FIG. 1A, the parallax filter 15 in the naked-eye stereoscopic display system guides a plurality of pixels on the display panel 13 to the user's left eye LE and right eye RE. For example, a first display pixel area (i.e., the first viewpoint image) is guided to the left eye position, and a second display pixel area (i.e., the second viewpoint image) is guided to the right eye position.

It shall be appreciated that the parallax filter 15 can split the pixel light of the display panel 13 into a first display pixel area and a second display pixel area (i.e., the first view area and the second view area) by the light splitting principle of the parallax filter. The eyes may see the pixels in the first view area or the pixels in the second view area when the eyes are within the view area.

However, due to the error of the parallax filter or other reasons, the generated view area may cause the user to see a no-value pixel area with a pixel value of zero, which may cause defects in the stereoscopic image.

For ease of understanding, please continue to refer to the view area diagram VA in FIG. 1A, which exemplifies the view area corresponding to the pixels on the display panel 13, and the number “1” represents the first display pixel area R1 (i.e., the pixels are guided to the left eye position), the number “2” represents the second display pixel area R2 (i.e., the pixels are guided to the right eye position), and the number “0” represents the no-value pixel area NPA (i.e., the pixels have no pixel value). As mentioned in the previous description, the user may see a no-value pixel area (marked with black background) without a pixel value due to various reasons (e.g., the viewing angle of the user is different, the light-splitting mechanism of the parallax filter itself cannot be completely perfect, etc.), which may cause defects in the image of the stereoscopic image. In order to solve the aforementioned problems, the present disclosure proposes several embodiments, the contents of which will be described in detail below.

The first embodiment of the present disclosure will be described first, and its schematic diagram is depicted in FIG. 1B. As shown in FIG. 1B, in the first embodiment of the present disclosure, the stereoscopic display system 1 comprises an eye tracking device 11, a display panel 13, a parallax filter 15, and a processing device 17. The processing device 17 may be connected to the eye tracking device 11 and the display panel 13 through wired or wireless network communication.

In the present embodiment, the eye tracking device 11 may sense the left eye position and the right eye position of the user. It shall be appreciated that the eye tracking device 11 is a device capable of tracking and measuring eye position and eye movement information. The eye tracking device 11 may obtain the left eye position and the right eye position of the user by performing techniques such as eye tracking.

In the present embodiment, the display panel 13 is configured to display a plurality of pixels. For example, the display panel 13 may display the first display pixel area and the second display pixel area through the pixels on the panel. The parallax filter 15 is configured to guide the pixels on the display panel 13 to the left eyeball position and the right eyeball position, for example, through lenses with various refraction angles.

In the present embodiment, the processing device 17 may be any of various processors, Central Processing Units (CPUs), microprocessors, digital signal processors or other computing apparatuses known to those of ordinary skill in the art. It shall be appreciated that, in some embodiments, the eye tracking device may also be integrated into the processing device, or implemented in the form of software (e.g., a software program that can achieve eye tracking by analyzing images).

In the present embodiment, the processing device 17 first calculates a viewing angle of the user corresponding to the display panel 13. Specifically, the processing device 17 may calculate the viewing angle through the following operations: calculating an eyeball center position based on the left eyeball position and the right eyeball position; and calculating the viewing angle based on the eyeball center position and a center position of the display panel 13.

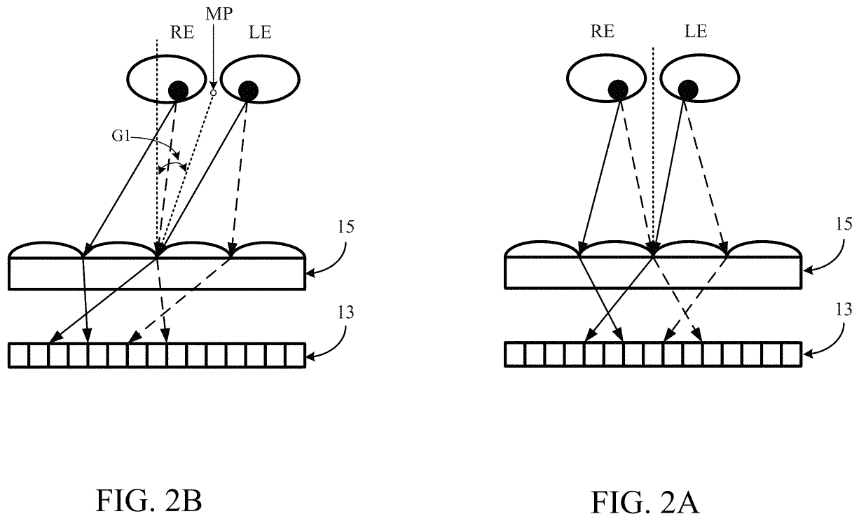

For ease of understanding, please refer to FIG. 2A and FIG. 2B at the same time. FIG. 2A illustrates a state where the viewing angle of the user is 0 degrees, and FIG. 2B illustrates a state where the viewing angle of the user is 25 degrees.

Taking FIG. 2B as an example, the processing device 17 first calculates the eyeball center position MP based on the left eyeball position LE and the right eyeball position RE. Next, the processing device 17 calculates the viewing angle G1 based on the eyeball center position MP and a center position of the display panel 13. In some embodiments, the processing device 17 may also calculate the distance between the eyeball center position MP and the extension line of the center position of the display panel 13, and calculate the viewing angle G1 through an arctangent function.

Next, the processing device 17 calculates a first display pixel area arrangement and a second display pixel area arrangement of the display panel 13 corresponding to the parallax filter 15, wherein the first display pixel area arrangement and the second display pixel area arrangement comprise a pixel value corresponding to each of the pixels.

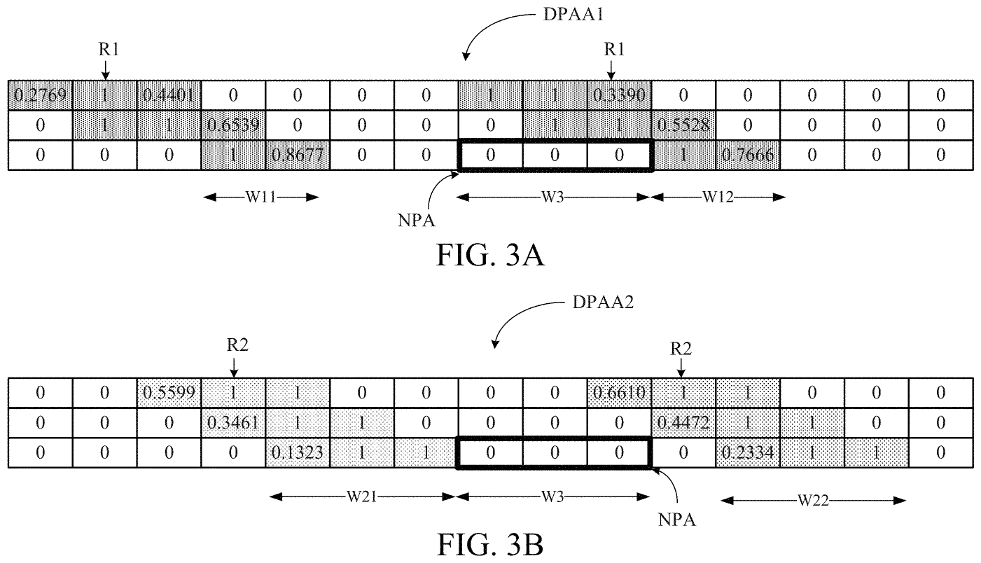

For ease of understanding, FIG. 3A illustrates the first display pixel area arrangement DPAA1, and FIG. 3B illustrates the second display pixel area arrangement DPAA2. In FIG. 3A and FIG. 3B, the first display pixel area arrangement DPAA1 and the second display pixel area arrangement DPAA2 correspond to a plurality of pixels (i.e., the pixels on the display panel 13) in the same three rows and correspond to their respective pixel values. In the present embodiment, the pixels in the first display pixel area arrangement DPAA1 are guided to the left eye position LE, and the pixels in the second display pixel area arrangement DPAA2 are guided to the right eye position RE.

It shall be appreciated that the processing device 17 may calculate the first display pixel area arrangement DPAA1 and the second display pixel area arrangement DPAA2 through various methods (e.g., optical ray tracing). Those with ordinary knowledge in the art should be able to understand the generation method of the first display pixel area arrangement DPAA1 and the second display pixel area arrangement DPAA2 according to the foregoing description, so no further description is needed.

Next, the processing device 17 determines the first display pixel area R1, the second display pixel area R2, and no-value pixel area NPA corresponding to the display panel 13 based on the first display pixel area arrangement DPAA1 and the second display pixel area arrangement DPAA2.

In some embodiments, the processing device 17 determines the pixel values in the first display pixel area arrangement DPAA1 to classify the pixels in the first display pixel area arrangement DPAA1 whose pixel values are not zero as the first display pixel area R1. For example, as shown in FIG. 3A, the processing device 17 classifies the pixels having the pixel value in the first display pixel area arrangement DPAA1 into the first display pixel area R1.

In some embodiments, the processing device 17 determines the pixel values in the second display pixel area arrangement DPAA2 to classify the pixels in the second display pixel area arrangement DPAA2 whose pixel values are not zero as the second display pixel area R2. For example, as shown in FIG. 3B, the processing device 17 classifies the pixels having the pixel value in the second display pixel area arrangement DPAA2 into the second display pixel area R2.

In some embodiments, the processing device 17 determines the pixel values in the first display pixel area arrangement DPAA1 and the second display pixel area arrangement DPAA2 to use the pixels whose pixel values are all zero as the no-value pixel area NPA, wherein the pixels in the no-value pixel area correspond to the pixel values in the first display pixel area arrangement DPAA1 and the second display pixel area arrangement DPAA2 are all zero. For example, taking the pixels in the lowermost row in FIG. 3A and FIG. 3B as an example, the processing device 17 classifies the pixels whose pixel values are all zero (i.e., the pixel values in the first display pixel area arrangement DPAA1 and the second display pixel area arrangement DPAA2 are both zero) to the no-value pixel area NPA.

Next, the processing device 17 analyzes the first display pixel area R1 and the second display pixel area R2 adjacent to the no-value pixel area NPA to generate a compensation value corresponding to each of the pixels in the no-value pixel area NPA.

It shall be appreciated that, when corresponding to different magnitudes of viewing angles, the compensation mechanism for generating the compensation value by the processing device 17 may also be different. For example, when the viewing angle range is not large (e.g., between 0 degrees and 30 degrees), an even distribution can be used (i.e., the ratio of the first display pixel area R1 and the second display pixel area R2 is the same) to compensate those pixels in the no-value pixel area NPA.

In some embodiments, the processing device 17 further determines the value of the viewing angle to determine the mechanism that needs to be compensated. Specifically, the processing device 17 compares the viewing angle with a predetermined angle (e.g., 30 degrees) to select a first compensation mechanism or a second compensation mechanism to generate the compensation value corresponding to each of the pixels in the no-value pixel area NPA.

It shall be appreciated that the predetermined angle can be adjusted based on the size of the display panel 13. For example, when the size of the display panel 13 is 15.6 inches, the predetermined angle can be set to 20 degrees, and when the size of the display panel 13 is 18 inches, the predetermined angle can be set to 10 degrees.

In some implementations, when the processing device 17 determines that the viewing angle is smaller than the predetermined angle, the processing device 17 selects the first compensation mechanism to generate the compensation value corresponding to each of the pixels in the no-value pixel area NPA. Specifically, the first compensation mechanism preferentially assigns the compensation value to the pixels near the first display pixel area R1 in the no-value pixel area NPA based on a horizontal width value and a first compensation ratio corresponding to the no-value pixel area NPA, and preferentially assigns the compensation value to the pixels near the second display pixel area R2 in the no-value pixel area NPA based on the horizontal width value and a second compensation ratio corresponding to the no-value pixel area NPA. Furthermore, the first compensation ratio is the same as the second compensation ratio.

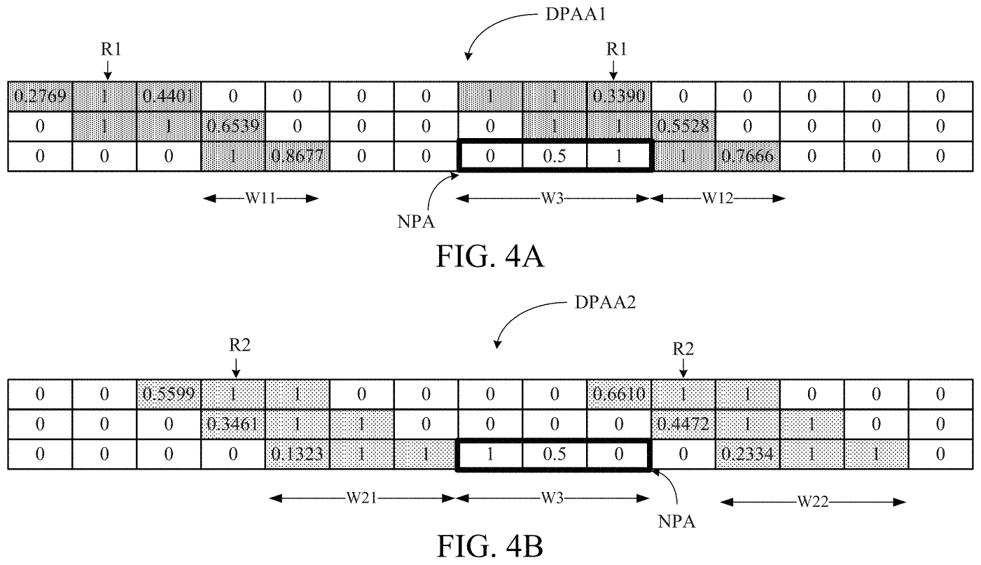

For ease of understanding, taking an actual example as an example, please refer to FIG. 4A and FIG. 4B, which illustrate the compensated FIG. 3A and FIG. 3B respectively (take the middle of the bottom row of the no-value pixel area NPA as an example).

In the present example, since the viewing angle is smaller than the predetermined angle, the first compensation mechanism is selected (i.e., the first compensation ratio is the same as the second compensation ratio, and the first compensation ratio and the second compensation ratio are both 50%). As shown in FIG. 4A and FIG. 4B, the processing device 17 calculates the horizontal width value W3 corresponding to the no-value pixel area NPA is 3. Therefore, the processing device 17 allocates the horizontal width value W3 to each of the first display pixel area R1 and the second display pixel area by 1.5 according to an average ratio, and assigns the compensation value starting from the pixels adjacent to the no-value pixel area NPA.

Specifically, in the first display pixel area arrangement DPAA1, the processing device 17 sequentially assigns the compensation value from the pixels near the first display pixel area R1. In the second display pixel area arrangement DPAA2, the processing device 17 sequentially assigns the compensation value from pixels near the second display pixel area R2, and the pixel value corresponding to each pixel is at most 1.

In some implementations, when the processing device 17 determines that the viewing angle is greater than the predetermined angle, the processing device 17 selects the second compensation mechanism to generate the compensation value corresponding to each of the pixels in the no-value pixel area NPA. Specifically, the second compensation mechanism preferentially assigns the compensation value to the pixels near the first display pixel area R1 in the no-value pixel area NPA based on a horizontal width value and a third compensation ratio corresponding to the no-value pixel area NPA, and preferentially assigns the compensation value to the pixels near the second display pixel area R2 in the no-value pixel area NPA based on the horizontal width value and a fourth compensation ratio corresponding to the no-value pixel area NPA.

In some embodiments, the third compensation ratio is the ratio of the horizontal width value corresponding to the first display pixel area R1 to an overall horizontal width value, the fourth compensation ratio is the ratio of the horizontal width value corresponding to the second display pixel area R2 to the overall horizontal width value, and the overall horizontal width value is a sum of the horizontal width value corresponding to the first display pixel area R1 and the horizontal width value corresponding to the second display pixel area R2.

For example, the third compensation ratio can be expressed by the following equation:

Ratio 3=W11+W12/W11+W12+W21+W22

For example, the fourth compensation ratio can be expressed by the following equation:

Ratio4=W21+W22/W11+W12+W21+W22

In the above two equations, W11 and W12 are the horizontal width values corresponding to the first display pixel area R1, and W21 and W22 are the horizontal width values corresponding to the second display pixel area R2.

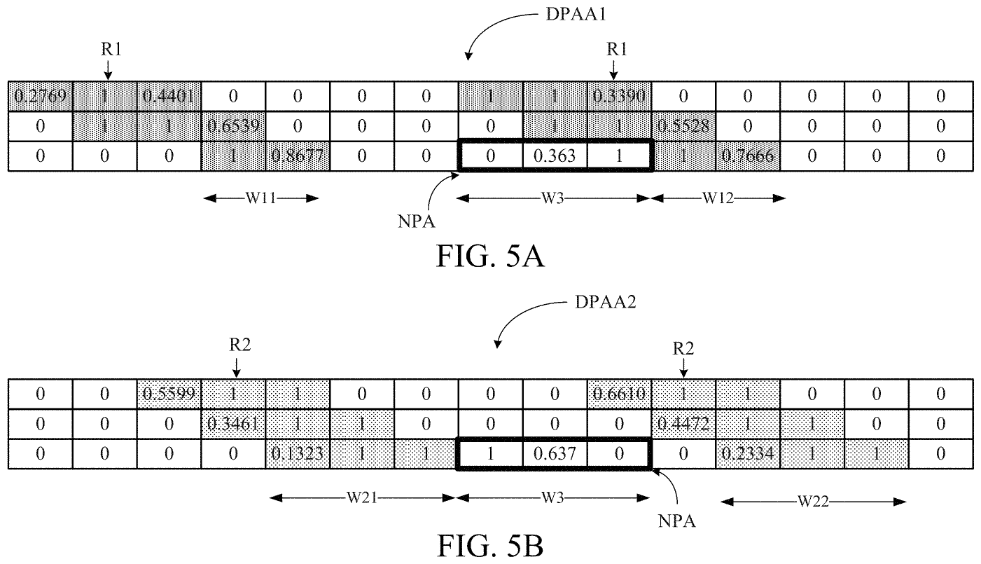

For ease of understanding, taking an actual example as an example, please refer to FIG. 5A and FIG. 5B, which illustrate the compensated FIG. 3A and FIG. 3B, respectively (taking the pixels in the middle of the bottom row of the no-value pixel area NPA as an example).

In the present example, since the viewing angle is larger than the predetermined angle, the second compensation mechanism is selected (i.e., based on the third compensation ratio and the fourth compensation ratio). As shown in FIG. 5A and FIG. 5B, after the processing device 17 calculating, the horizontal width value W3 corresponding to the no-value pixel area NPA is 3, the horizontal width value W11 is 1.8677 (i.e., the sum of the pixel values), and the horizontal width value W12 is 1.7666, the horizontal width value W21 is 2.1323, and the horizontal width value W22 is 2.2334. Next, according to the third compensation ratio (i.e., 0.454) and the fourth compensation ratio (i.e., 0.546), the processing device 17 assigns the horizontal width value W3 to the first display pixel area R1 with a compensation value of 1.363 and the second display pixel region with a compensation value of 1.637, and the allocation starts from the pixels adjacent to the no-value pixel area NPA.

According to the above descriptions, the stereoscopic display system provided by the present disclosure calculates the viewing angle of the display panel corresponding to the user, and calculates a first display pixel area arrangement and a second display pixel area arrangement of the display panel corresponding to the parallax filter. In addition, based on the first display pixel area arrangement and the second display pixel area arrangement, a first display pixel area, a second display pixel area and a no-value pixel area corresponding to the display panel are determined. Finally, the present disclosure analyzes the first display pixel area and the second display pixel area adjacent to the no-value pixel area to generate a compensation value corresponding to each of the pixels in the no-value pixel area. The stereoscopic display system provided by the present disclosure generates the compensation value of each pixel in the no-value pixel area by determining the no-value pixel area and considering the values of the adjacent pixels. Therefore, the present disclosure can solve the problem of defective images such as black lines when users use the stereoscopic display system. In addition, the stereoscopic display system provided by the present disclosure can make real-time compensation for each pixel in the no-value pixel area, so that the picture quality of the naked-eye stereoscopic display can be further improved.

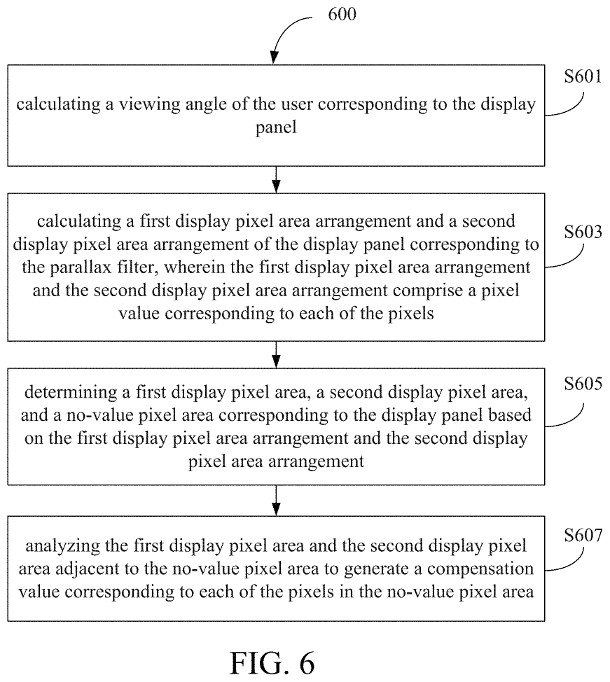

A second embodiment of the present disclosure is a stereoscopic display method and a flowchart thereof is depicted in FIG. 6. The stereoscopic display method 600 is adapted for a stereoscopic display system (e.g., the stereoscopic display system 1 of the first embodiment). The stereoscopic display system comprises an eye tracking device, a display panel, a parallax filter, and a processing device (e.g., the eye tracking device 11, the display panel 13, the parallax filter 15, and the processing device 17 of the first embodiment). The eye tracking device is configured to sense a left eyeball position and a right eyeball position of a user. The display panel is configured to display a plurality of pixels. The parallax filter is configured to guide the pixels on the display panel to the left eyeball position and the right eyeball position. The stereoscopic display method 600 generates a compensation value corresponding to each of the pixels in the no-value pixel area through steps S601 to S607.

In the step S601, the processing device calculates a viewing angle of the user corresponding to the display panel. Next, in the step S603, the processing device calculates a first display pixel area arrangement and a second display pixel area arrangement of the display panel corresponding to the parallax filter, wherein the first display pixel area arrangement and the second display pixel area arrangement comprise a pixel value corresponding to each of the pixels.

Next, in the step S605, the processing device determines a first display pixel area, a second display pixel area, and a no-value pixel area corresponding to the display panel based on the first display pixel area arrangement and the second display pixel area arrangement. Finally, in the step S607, the processing device analyzes the first display pixel area and the second display pixel area adjacent to the no-value pixel area to generate a compensation value corresponding to each of the pixels in the no-value pixel area.

In some embodiments, the stereoscopic display method 600 further comprises following steps: calculating an eyeball center position based on the left eyeball position and the right eyeball position; and calculating the viewing angle based on the eyeball center position and a center position of the display panel.

In some embodiments, the pixels in the first display pixel area arrangement are guided to the left eyeball position, and the pixels in the second display pixel area arrangement are guided to the right eyeball position.

In some embodiments, the stereoscopic display method 600 further comprises following steps: determining the pixel values in the first display pixel area arrangement to classify the pixels in the first display pixel area arrangement whose pixel values are not zero as the first display pixel area.

In some embodiments, the stereoscopic display method 600 further comprises following steps: determining the pixel values in the second display pixel area arrangement to classify the pixels in the second display pixel area arrangement whose pixel values are not zero as the second display pixel area.

In some embodiments, the stereoscopic display method 600 further comprises following steps: determining the pixel values in the first display pixel area arrangement and the second display pixel area arrangement to use the pixels whose pixel values are all zero as the no-value pixel area; wherein, the pixels in the no-value pixel area correspond to the pixel values in the first display pixel area arrangement and the second display pixel area arrangement are all zero.

In some embodiments, the stereoscopic display method 600 further comprises following steps: comparing the viewing angle with a predetermined angle to select a first compensation mechanism or a second compensation mechanism to generate the compensation value corresponding to each of the pixels in the no-value pixel area.

In some embodiments, the stereoscopic display method 600 further comprises following steps: selecting the first compensation mechanism to generate the compensation value corresponding to each of the pixels in the no-value pixel area when the viewing angle is smaller than the predetermined angle; wherein the first compensation mechanism preferentially assigns the compensation value to the pixels near the first display pixel area in the no-value pixel area based on a horizontal width value and a first compensation ratio corresponding to the no-value pixel area, and preferentially assigns the compensation value to the pixels near the second display pixel area in the no-value pixel area based on the horizontal width value and a second compensation ratio corresponding to the no-value pixel area; wherein the first compensation ratio is the same as the second compensation ratio.

In some embodiments, the stereoscopic display method 600 further comprises following steps: selecting the second compensation mechanism to generate the compensation value corresponding to each of the pixels in the no-value pixel area when the viewing angle is greater than the predetermined angle; wherein the second compensation mechanism preferentially assigns the compensation value to the pixels near the first display pixel area in the no-value pixel area based on a horizontal width value and a third compensation ratio corresponding to the no-value pixel area, and preferentially assigns the compensation value to the pixels near the second display pixel area in the no-value pixel area based on the horizontal width value and a fourth compensation ratio corresponding to the no-value pixel area.

In some embodiments, the third compensation ratio is the ratio of the horizontal width value corresponding to the first display pixel area to an overall horizontal width value, the fourth compensation ratio is the ratio of the horizontal width value corresponding to the second display pixel area to the overall horizontal width value, and the overall horizontal width value is a sum of the horizontal width value corresponding to the first display pixel area and the horizontal width value corresponding to the second display pixel area.

In addition to the aforesaid steps, the second embodiment can also execute all the operations and steps of the stereoscopic display system 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present disclosure, some words (e.g., the display pixel area arrangement, the display pixel area, the compensation mechanism, and the compensation ratio, etc.) are preceded by terms such as “first”, “second”, “third”, and “fourth”, and these terms of “first”, “second”, “third”, and “fourth” are only used to distinguish these different words. For example, the “third” and “fourth” of the third compensation ratio and the fourth compensation ratio are only used to indicate the compensation ratio used in different operations.

According to the above descriptions, the stereoscopic display technology (at least including the system and method) provided by the present disclosure calculates the viewing angle of the display panel corresponding to the user, and calculates a first display pixel area arrangement and a second display pixel area arrangement of the display panel corresponding to the parallax filter. In addition, based on the first display pixel area arrangement and the second display pixel area arrangement, a first display pixel area, a second display pixel area and a no-value pixel area corresponding to the display panel are determined. Finally, the present disclosure analyzes the first display pixel area and the second display pixel area adjacent to the no-value pixel area to generate a compensation value corresponding to each of the pixels in the no-value pixel area. The stereoscopic display technology provided by the present disclosure generates the compensation value of each pixel in the no-value pixel area by determining the no-value pixel area and considering the values of the adjacent pixels. Therefore, the present disclosure can solve the problem of defective images such as black lines when users use the stereoscopic display system. In addition, the stereoscopic display technology provided by the present disclosure can make real-time compensation for each pixel in the no-value pixel area, so that the picture quality of the naked-eye stereoscopic display can be further improved.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A stereoscopic display system, comprising:
an eye tracking device, being configured to sense a left eyeball position and a right eyeball position of a user;
a display panel, being configured to display a plurality of pixels;
a parallax filter, being configured to guide the pixels on the display panel to the left eyeball position and the right eyeball position; and
a processing device, being configured to perform operations comprising:
calculating a viewing angle of the user corresponding to the display panel;
calculating a first display pixel area arrangement and a second display pixel area arrangement of the display panel corresponding to the parallax filter, wherein the first display pixel area arrangement and the second display pixel area arrangement comprise a pixel value corresponding to each of the pixels;
determining a first display pixel area, a second display pixel area, and a no-value pixel area corresponding to the display panel based on the first display pixel area arrangement and the second display pixel area arrangement; and
analyzing the first display pixel area and the second display pixel area adjacent to the no-value pixel area to generate a compensation value corresponding to each of the pixels in the no-value pixel area.

2. The stereoscopic display system of claim 1, wherein the processing device further performs following operations:
calculating an eyeball center position based on the left eyeball position and the right eyeball position; and
calculating the viewing angle based on the eyeball center position and a center position of the display panel.

3. The stereoscopic display system of claim 1, wherein the pixels in the first display pixel area arrangement are guided to the left eyeball position, and the pixels in the second display pixel area arrangement are guided to the right eyeball position.

4. The stereoscopic display system of claim 1, wherein the processing device further performs following operations:
determining the pixel values in the first display pixel area arrangement to classify the pixels in the first display pixel area arrangement whose pixel values are not zero as the first display pixel area.

5. The stereoscopic display system of claim 1, wherein the processing device further performs following operations:
determining the pixel values in the second display pixel area arrangement to classify the pixels in the second display pixel area arrangement whose pixel values are not zero as the second display pixel area.

6. The stereoscopic display system of claim 1, wherein the processing device further performs following operations:
determining the pixel values in the first display pixel area arrangement and the second display pixel area arrangement to use the pixels whose pixel values are all zero as the no-value pixel area;
wherein, the pixels in the no-value pixel area correspond to the pixel values in the first display pixel area arrangement and the second display pixel area arrangement are all zero.

7. The stereoscopic display system of claim 1, wherein the processing device further performs following operations:
comparing the viewing angle with a predetermined angle to select a first compensation mechanism or a second compensation mechanism to generate the compensation value corresponding to each of the pixels in the no-value pixel area.

8. The stereoscopic display system of claim 7, wherein the processing device further performs following operations:
selecting the first compensation mechanism to generate the compensation value corresponding to each of the pixels in the no-value pixel area when the viewing angle is smaller than the predetermined angle;
wherein the first compensation mechanism preferentially assigns the compensation value to the pixels near the first display pixel area in the no-value pixel area based on a horizontal width value and a first compensation ratio corresponding to the no-value pixel area, and preferentially assigns the compensation value to the pixels near the second display pixel area in the no-value pixel area based on the horizontal width value and a second compensation ratio corresponding to the no-value pixel area;
wherein the first compensation ratio is the same as the second compensation ratio.

9. The stereoscopic display system of claim 7, wherein the processing device further performs following operations:
selecting the second compensation mechanism to generate the compensation value corresponding to each of the pixels in the no-value pixel area when the viewing angle is greater than the predetermined angle;
wherein the second compensation mechanism preferentially assigns the compensation value to the pixels near the first display pixel area in the no-value pixel area based on a horizontal width value and a third compensation ratio corresponding to the no-value pixel area, and preferentially assigns the compensation value to the pixels near the second display pixel area in the no-value pixel area based on the horizontal width value and a fourth compensation ratio corresponding to the no-value pixel area.

10. The stereoscopic display system of claim 9, wherein the third compensation ratio is a ratio of the horizontal width value corresponding to the first display pixel area to an overall horizontal width value, the fourth compensation ratio is the ratio of the horizontal width value corresponding to the second display pixel area to the overall horizontal width value, and the overall horizontal width value is a sum of the horizontal width value corresponding to the first display pixel area and the horizontal width value corresponding to the second display pixel area.

11. A stereoscopic display method, being adapted for use in a stereoscopic display system, wherein the stereoscopic display system comprises an eye tracking device, a display panel, a parallax filter, and a processing device, the eye tracking device is configured to sense a left eyeball position and a right eyeball position of a user, the display panel is configured to display a plurality of pixels, the parallax filter is configured to guide the pixels on the display panel to the left eyeball position and the right eyeball position, and the stereoscopic display method comprises following steps:
calculating a viewing angle of the user corresponding to the display panel;
calculating a first display pixel area arrangement and a second display pixel area arrangement of the display panel corresponding to the parallax filter, wherein the first display pixel area arrangement and the second display pixel area arrangement comprise a pixel value corresponding to each of the pixels;
determining a first display pixel area, a second display pixel area, and a no-value pixel area corresponding to the display panel based on the first display pixel area arrangement and the second display pixel area arrangement; and
analyzing the first display pixel area and the second display pixel area adjacent to the no-value pixel area to generate a compensation value corresponding to each of the pixels in the no-value pixel area.

12. The stereoscopic display method of claim 11, wherein the stereoscopic display method further comprises following steps:
calculating an eyeball center position based on the left eyeball position and the right eyeball position; and
calculating the viewing angle based on the eyeball center position and a center position of the display panel.

13. The stereoscopic display method of claim 11, wherein the pixels in the first display pixel area arrangement are guided to the left eyeball position, and the pixels in the second display pixel area arrangement are guided to the right eyeball position.

14. The stereoscopic display method of claim 11, wherein the stereoscopic display method further comprises following steps:
determining the pixel values in the first display pixel area arrangement to classify the pixels in the first display pixel area arrangement whose pixel values are not zero as the first display pixel area.

15. The stereoscopic display method of claim 11, wherein the stereoscopic display method further comprises following steps:
determining the pixel values in the second display pixel area arrangement to classify the pixels in the second display pixel area arrangement whose pixel values are not zero as the second display pixel area.

16. The stereoscopic display method of claim 11, wherein the stereoscopic display method further comprises following steps:
determining the pixel values in the first display pixel area arrangement and the second display pixel area arrangement to use the pixels whose pixel values are all zero as the no-value pixel area;
wherein, the pixels in the no-value pixel area correspond to the pixel values in the first display pixel area arrangement and the second display pixel area arrangement are all zero.

17. The stereoscopic display method of claim 11, wherein the stereoscopic display method further comprises following steps:
comparing the viewing angle with a predetermined angle to select a first compensation mechanism or a second compensation mechanism to generate the compensation value corresponding to each of the pixels in the no-value pixel area.

18. The stereoscopic display method of claim 17, wherein the stereoscopic display method further comprises following steps:
selecting the first compensation mechanism to generate the compensation value corresponding to each of the pixels in the no-value pixel area when the viewing angle is smaller than the predetermined angle;
wherein the first compensation mechanism preferentially assigns the compensation value to the pixels near the first display pixel area in the no-value pixel area based on a horizontal width value and a first compensation ratio corresponding to the no-value pixel area, and preferentially assigns the compensation value to the pixels near the second display pixel area in the no-value pixel area based on the horizontal width value and a second compensation ratio corresponding to the no-value pixel area;
wherein the first compensation ratio is the same as the second compensation ratio.

19. The stereoscopic display method of claim 17, wherein the stereoscopic display method further comprises following steps:
selecting the second compensation mechanism to generate the compensation value corresponding to each of the pixels in the no-value pixel area when the viewing angle is greater than the predetermined angle;
wherein the second compensation mechanism preferentially assigns the compensation value to the pixels near the first display pixel area in the no-value pixel area based on a horizontal width value and a third compensation ratio corresponding to the no-value pixel area, and preferentially assigns the compensation value to the pixels near the second display pixel area in the no-value pixel area based on the horizontal width value and a fourth compensation ratio corresponding to the no-value pixel area.

20. The stereoscopic display method of claim 19, wherein the third compensation ratio is a ratio of the horizontal width value corresponding to the first display pixel area to an overall horizontal width value, the fourth compensation ratio is the ratio of the horizontal width value corresponding to the second display pixel area to the overall horizontal width value, and the overall horizontal width value is a sum of the horizontal width value corresponding to the first display pixel area and the horizontal width value corresponding to the second display pixel area.
